(19) United States
(12) Patent Application Publication
(10) Pub. No.: US 2016/0275539 A1
(43) Pub. Date: Sep. 22, 2016

(54) Systems and Methods for Managing Reward Payments for Search Results by Search Engines

(71) Applicant: MASTERCARD INTERNATIONAL INCORPORATED, Purchase, NY (US)

(72) Inventors: Scott Robert Hudson, Rye, NY (US); Kent Olof Niklas Berntsson, Rye, NY (US)

(21) Appl. No.: 14/719,672

(22) Filed: May 22, 2015

Related U.S. Application Data
(60) Provisional application No. 62/135,021, filed on Mar. 18, 2015.

(51) Int. Cl. G06Q 30/02

(52) U.S. Cl. CPC G06Q 30/0222

(57) ABSTRACT

Systems and methods are provided for managing reward payment for search engines to improve identification of consumer merchants (e.g., increase exposure, increase relevance, improve ranking, etc.) in search results from search engines in connection with search requests for the consumer merchants. One exemplary method generally includes receiving a request, from the consumer merchant, for a search benefit associated with the search engine; reducing, by the at least one server, a reward total for the consumer merchant by an amount associated with the search benefit; and transmitting an indicator of the purchased search benefit to the search engine.

### CROSS-REFERENCE TO RELATED APPLICATION

This application claims the benefit of and priority to U.S. Provisional Application No. 62/135,021 filed on Mar. 18, 2015. The entire disclosure of the above application is incorporated herein by reference.

### FIELD

The present disclosure generally relates to managing reward payments for search results by search engines. More particularly, the present disclosure relates to systems and methods for use in redeeming rewards, for example, for improved identification of consumers (and/or their business, etc.) (e.g., increased exposure, increased relevance, improved ranking, etc.) in search results at search engines in connection with search requests relating to the consumers (and/or their business).

### BACKGROUND

This section provides background information related to the present disclosure which is not necessarily prior art.

Consumers often use payment devices, and payment accounts associated therewith, in transactions to purchase products (e.g., goods and/or services, etc.) from merchants. The payment devices, and associated payment accounts, are typically provided to the consumers by issuers. In certain instances, consumers earn rewards for using the payment devices. The rewards are based on total amounts, or values, of the purchases made with the payment devices and processed to the payment accounts. Separately, some consumers are known to have websites (e.g., associated with businesses operated by the consumers, or otherwise associated with information disseminated by the consumers, etc.) that are viewable online, and that other entities can find, for example, via searches through one or more search engines.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use to aggregate rewards earned by consumer merchants for transactions processed to their payment accounts and to redeem the rewards for improved identification in search results from search engines;

FIG. 2 is a block diagram of a computing device, that may be used in the exemplary system of FIG. 1;

FIG. 3 is an exemplary method for managing rewards earned by a consumer merchant, that may be implemented in connection with the system of FIG. 1; and

FIGS. 4A and 4B are exemplary interfaces illustrating example search result from a search engine, after and before a search benefit is applied.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers use payment devices, associated with payment accounts, to purchase products (e.g., goods and/or services, etc.) from merchants. Often, the payment devices and associated payment accounts are provided to the consumers by issuers that then assign rewards to the consumers based on transactions to the payment accounts. Typically, the rewards are based on total amounts of the transactions processed to the payment accounts, and are redeemed for cash, refunds, airline tickets, or other rewards, etc. Uniquely, the systems and methods described herein allow the consumers to redeem the rewards for improved identification (e.g., increased exposure, increased relevance, improved ranking, etc.) of the consumers (and/or their business) in search results, provided by search engines, in connection with search requests relating to the consumers (and/or their business) or in connection with advertising for the consumers (and/or their business) (e.g., digital advertising, etc.).

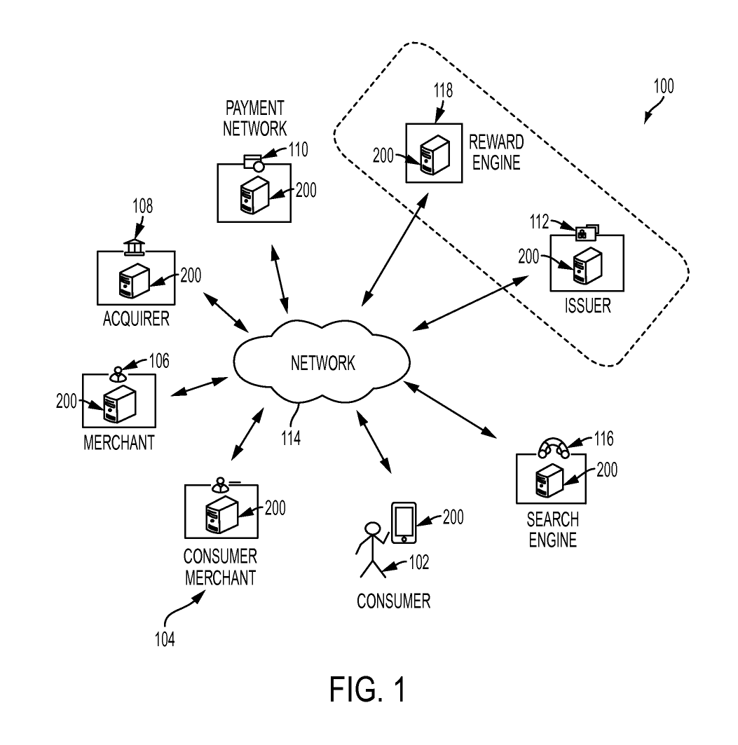

FIG. 1 illustrates an exemplary system 100 in which one or more aspects of the present disclosure may be implemented. Although components of the system 100 are presented in one arrangement, it should be appreciated that other exemplary embodiments may include the same or different components arranged otherwise, for example, depending on interactions and/or relationships between various components when managing rewards and/or performing searches for consumer merchants.

The illustrated system 100 generally includes a consumer 102, a consumer merchant 104 (e.g., a small business, or other business, etc. that also purchase products from other merchants, etc.), a merchant 106, an acquirer 108, a payment network 110, and an issuer 112, each coupled to network 114. The network 114 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof. In one example, the network 114 includes multiple networks, where different ones of the multiple networks are accessible to different ones of the illustrated components in FIG. 1.

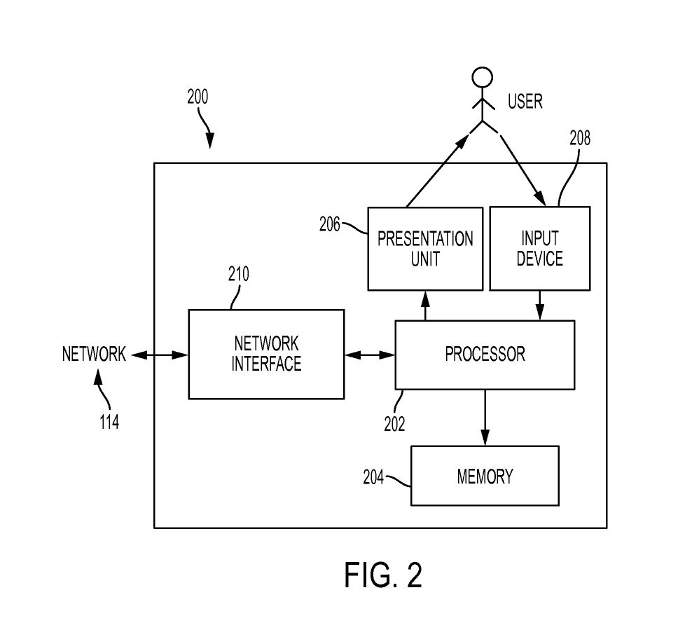

In addition, each of the consumer 102, the consumer merchant 104, the merchant 106, the acquirer 108, the payment network 110, and the issuer 112 in the system 100 is associated with, or implemented in, one or more computing devices. For illustration, the system 100 is described with reference to exemplary computing device 200, illustrated in FIG. 2. And, each of the consumer 102, the consumer merchant 104, the merchant 106, the acquirer 108, the payment network 110, and the issuer 112 in the system 100 is associated with such a computing device 200. However, the system 100 and its components should not be considered limited to the computing device 200, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region (such that each computing device 200 in the system 100 may represent multiple computing devices, etc.). Additionally, each computing device 200 illustrated in the system 100 may be coupled to a network (e.g., the Internet, an intranet, a private or public LAN, WAN, mobile network, telecommunication networks, combinations thereof, or other suitable network, etc.) that is either part of the network 114, or separate therefrom.

With reference to FIG. 2, the illustrated computing device 200 generally includes a processor 202, and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, tapes, flash drives, hard disks, and/or any other type of volatile or nonvolatile physical or tangible computer-readable media. The memory 204 may be configured to store, without limitation, data relating to payment accounts, data for transactions processed to the payment accounts, data relating to reward accounts, data relating to online search requests and search results, methodologies (e.g., algorithms, etc.) for identifying and ranking and/or ordering search hits (e.g., consumer merchants, other merchants, other entities, etc.) in response to search requests, and/or any other types of data suitable for use as described herein, etc.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

The illustrated computing device 200 also includes a presentation unit 206 that is coupled to the processor 202. The presentation unit 206 outputs, or presents, to a user (e.g., the consumer 102 in the system 100; individuals associated with one or more of the consumer merchant 104, the merchant 106, the acquirer 108, the payment network 110, and the issuer 112 in the system 100; individuals associated with search engine 116 in the system 100; individuals associated with reward engine 118 in the system 100; etc.) by, for example, displaying, audibilizing, and/or otherwise outputting data such as, but not limited to, data relating to payment accounts, data for transactions processed to the payment accounts, data relating to reward accounts, data relating to search requests and search results, methodologies (e.g., algorithms, etc.) for identifying and ranking and/or ordering search hits (e.g., consumer merchants, other merchants, other entities, etc.) from search request, and/or any other type of data. It should be further appreciated that, in some embodiments, the presentation unit 206 comprises a display device such that various interfaces (e.g., applications, webpages, etc.) may be displayed at computing device 200, and in particular at the display device, to display such information and data, etc. And in some examples, the computing device 200 may cause the interfaces to be displayed at a display device of another computing device, including, for example, a server hosting a website having multiple webpages, etc. With that said, presentation unit 206 may include, without limitation, a liquid crystal display (LCD), a light-emitting diode (LED) display, an organic LED (OLED) display, an “electronic ink” display, speakers, combinations thereof, etc. In some embodiments, presentation unit 206 includes multiple units.

The computing device 200 further includes an input device 208 that receives input from the user (e.g., search requests, etc.). The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, behaves as both a presentation unit and an input device. In at least one exemplary embodiment, a presentation unit and/or an input device are omitted from a computing device.

In addition, the illustrated computing device 200 includes a network interface 210 coupled to the processor 202 (and, in some embodiments, to the memory 204 as well). The network interface 210 may include, without limitation, a wired network adapter, a wireless network adapter, a mobile telecommunications adapter, or other device capable of communicating to one or more different networks, including the network 114. In some exemplary embodiments, the computing device 200 includes the processor 202 and one or more network interfaces incorporated into or with the processor 202.

By way of example (and without limitation), the exemplary computing device 200 may include one or more servers, personal computers, laptops, tablets, PDAs, telephones (e.g., cellular phones, smartphones, other phones, etc.), POS terminals, combinations thereof, etc. as appropriate.

Referring again to FIG. 1, the consumer 102 can transact with either the merchant 106 or the consumer merchant 104 in the system 100 for the purchase of products (e.g., goods and/or services). Similarly, the consumer merchant 104 (acting as a consumer) can transact with the merchant 106 for the purchase of products. The transactions may occur in-person at a location associated with the merchant 106 or consumer merchant 104, or remotely via telephonic, network, or other connections between the merchant 106, the consumer merchant 104, and the consumer 102 (e.g., via network 114, etc.). In order to process these purchase transactions, typically, the merchant 106 and/or the consumer merchant 104 (when acting as a merchant) enroll with the payment network 110 (e.g., through the acquirer 108, etc.), which then coordinates approval, settlement, etc. of the transactions through the system 100. While only one consumer 102, one merchant 106, one consumer merchant 104, one acquirer 108, and one issuer 112 are shown in FIG. 1, it should be appreciated that a different number of one or more of these entities may be included in other embodiments.

As an example, in the system 100, the merchant 106, the acquirer 108, the payment network 110, and the issuer 112 cooperate to process a request from the consumer merchant 104 (acting as a consumer) to complete a purchase transaction with the merchant 106, via a payment device. The payment device is associated with a payment account provided to the consumer merchant 104 by the issuer 112, and through which funds are made available to the consumer merchant 104 for use in the transaction.

In this example, the consumer merchant 104 (e.g., an individual associated with the consumer merchant 104, etc.) may initiate the transaction by presenting the payment device to the merchant 106. The merchant 106 reads payment account information associated with the payment device and communicates, via the network 114, an authorization request to the payment network 110, through the acquirer 108 (associated with the merchant 106), to process the transaction. The authorization request includes various details of the transaction (e.g., transaction data, etc.) to help facilitate processing the authorization request. The payment network 110, in turn, communicates the authorization request to the issuer 112 (associated with the consumer merchant's payment account). The issuer 112 then provides an authorization response (e.g., authorizing or declining the request) to the payment network 110, which is provided back through the acquirer 108 to the merchant 106. The transaction with the consumer merchant 104 is then completed, or not, by the merchant 106, depending on the authorization response. Other transactions in the system 100, involving the consumer merchant 104 and the merchant 106 (or involving the consumer merchant 104 and other merchants accommodated by the system 100 but not shown) are also processed in a similar manner.

The payment device used by the consumer merchant 104 may include any suitable device such as, for example, a payment card (e.g., a credit card, a debit card, a pre-paid card, etc.), another payment device (e.g., a fob, a smartphone, tablet, a laptop, etc.), or an enabled device through which login credentials for a previously established purchase account can be entered (e.g., to enable use of an electronic wallet such as MasterPass™, Google Wallet™, PayPass™, Softcard®, etc.), etc.

Transaction data is generated as part of the above interactions among the consumer merchant 104, the merchant 106, the acquirer 108, the payment network 110, and the issuer 112. Depending on the transaction, the transaction data is transmitted from the merchant 106 to the issuer 112 through the payment network 110 or otherwise (e.g., as part of the authorization request, etc.). The transaction data may include, without limitation, the payment account number (PAN) for the consumer merchant's payment account involved in the transaction, a payment amount for the product(s) involved in the transaction, identifier(s) for the product(s) involved in the transaction, description(s) of the product(s) involved in the transaction, a merchant name for the merchant 106 involved in the transaction, a merchant identification number (MID) for the merchant 106 involved in the transaction, a merchant category code (MCC) assigned to the merchant 106 involved in the transaction (e.g., by the payment network 110 or by another, based on a type of product(s) provided by the merchant 106, etc.), a date and/or time of the transaction, a location of the transaction, etc.

Once generated, the transaction data is stored in one or more different components of the system 100. In the illustrated embodiment, for example, the payment network 110 and/or the issuer 112 collect the transaction data and store it in memory 204 of associated computing devices 200 (e.g., in a data structure associated with the memory 204, etc.). As such, the payment network 110 and/or the issuer 112 include, in their memory 204, a compilation of consumer merchants and merchants involved in the various transactions processed by the payment network 110 (through the system 100, etc.), and the corresponding transaction data for the transactions. Further, the transaction data can be stored by the payment network 110 and/or the issuer 112, in their memory 204, in various different manners, for example, according to one or more of the payment accounts used by the consumer merchant 104, the merchant 106 (or other merchants) involved in the transactions (e.g., the MID for the merchant(s) involved, the MCC for the merchant(s) involved, etc.), or any other criteria, such that the transaction data is readily usable as described herein. It should be appreciated that the same or different transaction data may be collected and stored within other components of the system 100. In addition, while the transaction data is described as stored in the memory 204 of the computing device 200 associated with the payment network 110 and/or the issuer 112, it should be appreciated that the transaction data could be stored apart from the memory 204 (e.g., in data structures apart from the computing devices 200, etc.) in various implementations.

Similar transactions can be performed in the system 100 by the consumer 102, using a payment device, for products offered by the consumer merchant 104 (when acting as a merchant) or the merchant 106 (or other merchants). These transactions may be processed in a similar manner to the above example transaction between the consumer merchant 104 and the merchant 106, but may involve one or more different issuers and/or acquirers. Further, transaction data for these transactions may similarly be generated and stored in the system 100, as described above.

In various exemplary embodiments, consumers (e.g., consumer merchant 104, consumer 102, etc.) involved in the different transactions herein agree to legal terms associated with their payment accounts, for example, during enrollment in their accounts, etc. In so doing, the consumers may agree, for example, to allow merchants (e.g., consumer merchant 104, merchant 106, etc.), issuers of the payment accounts, payment networks, etc. to use data collected during enrollment and/or collected in connection with processing the transactions, subsequently for one or more of the different purposes described herein (e.g., for managing reward points earned by the consumers, etc.).

With continued reference to FIG. 1, the system 100 also includes search engine 116. The search engine 116 is associated with, or implemented in, one or more computing devices that facilitate operation of the search engine 116. For illustration, in the system 100, the search engine 116 is described with reference to exemplary computing device 200, illustrated in FIG. 2. However, as previously described, the search engine 116 should not be considered limited to the computing device 200, as different computing devices and/or arrangements of computing devices may be used.

In general, the search engine 116 is configured to search for and identify items, information (broadly, data), webpages, etc. in one or more databases (or networks) that correspond to keywords or characters specified in search requests (or search queries) from users (e.g., the consumer 102, the consumer merchant 104, etc.). To accomplish this, the search engine 116 employs one or more algorithms (or other methodologies) to identify a search result, which includes search hits (e.g., webpages/interfaces, information, documents, maps, and/or images associated with consumer merchants, other merchants, and/or other entities, etc.), based on the specified keywords or characters. In so doing, the one or more algorithms often account for popularity (e.g., hit frequency, etc.), relevance, other features, etc. of the various search hits, relative to the keywords or characters specified in the search request, to organize or order the search hits in a particular manner for display to the user. As such, in the system 100, the search engine 116 can be used by the consumer 102 to find particular websites (or interfaces), via the network, for the consumer merchant 104 or the merchant 106 (or for other merchants).

With that said, and without limitation, example search engines may include Google™, Google Play Store™, Google Maps™, Instagram™, Bing™, Apple iTunes™, Snapchat™, Foursquare™, Tinder™, Yelp™, LinkedIn™, Stumbleupon™, Yahoo™, Facebook™, Twitter™, Pinterest™, YouTube™, TripAdvisors™, Angie's List™, Photbucket™, YellowPages™, Reddit™, Tumblir™, Flickr™, Amazon™, eBay™, etc. As shown in the exemplary listing, the search engine 116 may be generic to various topics, or topic-specific, for example, to employment, travel, media (e.g., music, applications, etc.), services, social, news, product/merchant reviews, etc.

The system 100 further includes reward engine 118 configured, often by computer-readable instructions, to perform the various functions described herein. In the illustrated system 100, the reward engine 118 is associated with, or implemented in, computing device 200 (as illustrated in FIG. 2). However, again, the reward engine 118 should not be considered limited to the computing device 200, as different computing devices and/or arrangements of computing devices may be used. Also in the illustrated system 100, the reward engine 118 is a stand-alone entity. But it is contemplated that the reward engine 118 could be associated with (or incorporated into) the issuer 112 in some implementations (as indicated by the broken lines in FIG. 1). Additionally, or alternatively, in some embodiments, the reward engine 118 may be incorporated into the search engine 116. In still other embodiments, the reward engine 118 may be incorporated into other entities, for example, shown in the system 100 (e.g., the payment network 110, etc.), or not shown.

The reward engine 118, and in particular memory 204 associated with the reward engine 118, in various embodiments, comprises a data structure, which includes one or more reward accounts, each associated with one or more payment accounts (and/or one or more entities associated with the payment accounts, etc.). Typically, rewards are earned based on total amounts of the transactions processed to the payment accounts. The earned rewards are then accumulated and tracked in the reward accounts, with notifications and/or interfaces (e.g., badges, reward point indicators, etc.) of the rewards total sent to the consumer merchant 104 (thereby providing a gamification factor). And, the reward points can then be subsequently redeemed from the reward accounts as described more hereinafter.

The reward engine 118 may further comprise a data structure (that is the same as the above data structure, or separate therefrom), which includes transaction data related to the payment account. Depending on the particular embodiment, the transaction data may include transaction summaries and/or the individual transactions to the payment account, from either of which the reward engine 118 can access desired transaction data for use in modifying a reward total for particular reward accounts (e.g., by adding or subtracting reward points, etc.), as described more below. In other embodiments, the transaction data is accessed, by the reward engine 118, in a memory apart from the reward engine 118 (e.g., in the memory 204 of the payment network 110, in memory 204 of the issuer 112, etc.), prior to modifying the reward total.

As described in more detail next in method 300, the reward engine 118 is configured to facilitate redemption of the reward points for one or more search benefits from the search engine 116. In connection therewith, the search engine 116 may be affiliated with the consumer merchant's payment account (e.g., co-branded on the payment device associated with the payment account, etc.), such that the search benefits, redeemed from the reward points, can be used with the search engine 116 to provide improved identification (e.g., increased exposure, increased relevance, improved ranking, etc.) of the consumer merchant 104 in the search results from the search engine 116. As can be appreciated, this may result in improved online visibility of the consumer merchant 104 to the consumer 102 (and to other consumers submitting similar search requests to the search engine 116) and, thus, potentially increased sales.

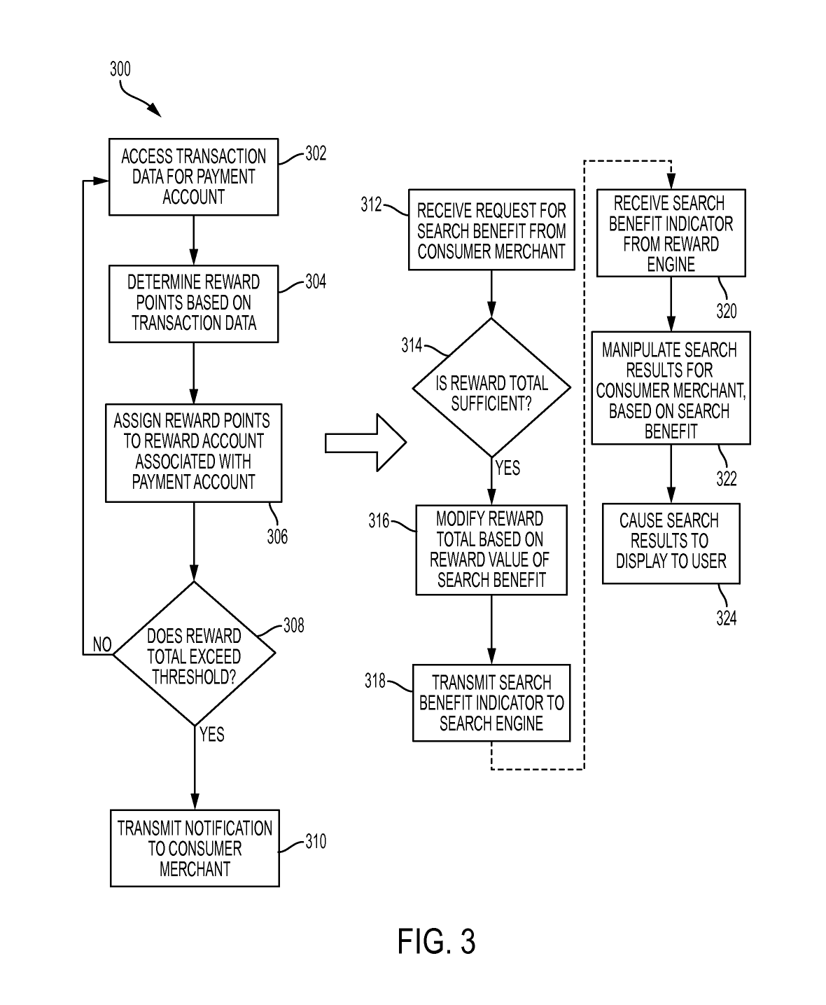

FIG. 3 illustrates exemplary method 300, for use in managing rewards earned by the consumer merchant 104, and redemption of the rewards, by the consumer merchant 104, to improve identification of the consumer merchant 104 in search results generated by the search engine 116 (for search requests relating to the consumer merchant 104). The exemplary method 300 is described as implemented in the reward engine 118 of the system 100 with it understood that the reward engine 118 is capable of performing one or more of the various operations of the method 300. Further reference is also made to the consumer 102, the consumer merchant 104, the merchant 106, the acquirer 108, the payment network 110, the issuer 112, and the search engine 116. However, the method 300 could be implemented in (or in connection with) one or more other entities, in other embodiments.

For purposes of illustration, the exemplary method 300 is also described herein with reference to the computing device 200. And, just as the method 300, and other methods herein, should not be understood to be limited to the exemplary system 100, or the exemplary computing device 200, the systems and the computing devices herein should not be understood to be limited to the exemplary method 300.

In the method 300, as used for the consumer merchant 104, the reward engine 118 initially accesses the transaction data associated with the consumer merchant's payment account, at 302. This includes accessing (and, in some implementations, retrieving) the transaction data, for the consumer merchant 104, from the memory 204 of the computing device 200 of the issuer 112 (e.g., directly, or via network 114, etc.), for example, for transactions made by the consumer merchant 104 and processed through the payment network 110 to the issuer 112. Alternatively, for example, when the reward engine 118 is otherwise situated, accessing transaction data may include accessing transaction data (as individual transactions, or in a different form, such as transaction summaries, for example), via one or more networks, such as network 114. In addition, in some implementations, the accessed transaction data may be limited, by the reward engine 118, to transaction data associated with transactions made during a predefined interval (e.g., the last month, the last three months, the last six months, the last year, the last two years, or transaction data since a last access, etc.), etc. In other embodiments, it should be appreciated that different transaction data may be accessed (e.g., all transaction data for the consumer merchant 104 regardless of payment account, all transaction data for a payment account regardless of time intervals and/or regardless of purchasing entity, all transaction data for a group of payment accounts, all transaction data for a group of consumer merchants, etc.). It should also be appreciated that, in some embodiments, the reward engine 118 may access transaction data from other payment networks and/or issuers, in addition to the payment network 110 and/or the issuer 112, such that multiple sources of transaction data may be accessed.

The reward engine 118 can access the transaction data on any desired schedule. For example, the reward engine 118 may access the transaction data continuously, so that new transactions are immediately available to the reward engine 118 for processing, as described herein (e.g., so that real-time (or near real-time) updates are available, etc.). Or, the reward engine 118 may access the transaction data at predefined intervals (e.g., daily, weekly, monthly, etc.). Generally, in several embodiments, however, once transaction data is accessed, and the total reward of the corresponding reward account is modified accordingly (as describe below), the reward engine 118 will attempt to avoid accessing the same data (or otherwise designate the data, or the interval of the data, as “already processed”) to avoid duplicative reward modifications for that transaction data.

In addition, in some embodiments, the accessed transaction data, and, for example, transactions included therein, may also be categorized previously or by the reward engine 118 for subsequent use. This may include, for example, assigning a category to the transaction data based on one or more of industries relating to the transactions, consumer identities, merchants involved in the transactions (e.g., merchant names, MCCs, MIDs, etc.), etc.

After accessing the transaction data, the reward engine 118 modifies the reward total associated with the payment account(s) (or of the associated reward account) based on the transaction data. In particular, in the example embodiment of FIG. 3, this includes the reward engine 118 determining or calculating reward points, at 304, based on the transaction data. For example, for each of the transactions included in the accessed transaction data, the reward engine 118 calculates reward points to be added or subtracted (e.g., chargeback transactions, etc.). The calculated reward points may be based on amounts of the transactions (e.g., one dollar corresponds to one reward point, etc.), or on a quantity of the transactions (e.g., additional reward points may be calculated for all transactions exceeding a threshold number of transactions, etc.), or on a category of the transactions (e.g., additional reward points may be calculated for all transactions having a particular MCC, etc.), or any combinations thereof.

Once the reward points are calculated (for a new transaction or group of transactions), the modification of the reward total further includes the reward engine 118 assigning the calculated reward points to a reward account, at 306, associated with the consumer merchant 104 and the consumer merchant's payment account. In so doing, the reward total for the account is increased or decreased, depending on the calculated rewards points, thus updating the reward total.

Next, the reward engine 118 compares the reward total of the consumer merchant's reward account to one or more predefined point thresholds, at 308. When the reward total exceeds (or is near) a predefined point threshold at 308, the reward engine 118 transmits a corresponding notification at 310 to the consumer merchant 104 (e.g., indicating the reward total, indicating reward thresholds, indicating that the reward total is near or exceeds a threshold, indicating search performance metrics (e.g., number of hits per period, number of hits compared to competitors, search result positions, etc.) for the search engine 116, etc.). Or, the reward engine 118 notifies the consumer merchant 104 through an interface associated with the search engine 116 and/or the reward engine 118 and/or the issuer 112, and accessible to the consumer merchant 104. The predefined threshold may include any desired threshold of points, for example, determined by the reward engine 118, determined by the consumer merchant 104, etc. and may correspond to particular values needed for particular search benefits, etc. (e.g., 500 points, 1,000 points, 10,000 points, etc.). In addition, the predefined threshold (e.g., the required amount to purchase or a percentage of the required amount to purchase (e.g., “half way to your next search benefit”, etc.) may also vary based on how long the search benefit is to apply, the time of the year the search benefit is to apply, or even the particular type of search benefit. Conversely, when the reward total does not exceed the threshold, at 308, the reward engine 118 repeats operations 302-306 for additional transaction data, as accessed, or for additional transactions.

With continued reference to FIG. 3, apart from the accumulation of reward points, the consumer merchant 104 may transmit a request to the reward engine 118 to redeem points from the reward account for a search benefit (e.g., directly, via the issuer 112, via the search engine 116, etc.). And, in turn, the reward engine 118 receives the request, at 312. The requested search benefit may include any one of a number of different search benefits, which may impact how or where a search hit associated with the consumer merchant 104 is included in a search result from the search engine 116. For example, a search benefit may cause a search hit associated with the consumer merchant 104 to be elevated, such as, for example, by three search hits, or to be elevated to the next page of search hits in the search result, or to be elevated to a particular page (e.g., the 1st page, 2nd page, etc.) of the search result, or to be elevated above 50% of all other search hits in the search result, or to be elevated above 75% of all other search hits in the search result, etc. In addition, or alternatively, the search benefit may include one or more particular keywords. For example, a florist may opt to purchase the keywords: flowers, Mother's Day, Valentine's Day, roses, etc., such that the purchased keywords are then associated with the florist by the search engine in connection with future search requests. As such, a webpage associated with the florist may be elevated (above other search hits not associated with a search benefit), potentially to the top of a search result, when the keywords are used in searches by users at the search engine 116. It should be appreciated that any different type of search benefit may be offered to the consumer merchant 104 to provide specific or general alteration to how and where, in a search result, the consumer merchant 104 (i.e., information, interfaces, and/or webpages associated therewith) is listed.

The search benefit is often associated with a particular predefined interval, such as for example, 1 week, 15 days, 1 month, 3 months, 1 year, etc. Typically, the interval of the search benefit is started when the search benefit is purchased. And, when the predefined interval expires, the search benefit no longer is used by the search engine 116, or is no longer effective, to manipulate a search result. In this manner, the consumer merchant 104 is able to purchase particular search benefits, as it accrues rewards, or at particular times, for example, related to peak purchasing times for the consumer merchant 104 (e.g., Valentine's Day for florists, etc.), etc.

In addition, or alternatively, the consumer merchant 104 may purchase particular search benefits that continue, as long as the consumer merchant 104 maintains a predefined amount of reward points in its reward account (i.e., rolling totals). Here, different thresholds of reward point balances may be provided for different search benefits. For example, reward points for the last 30 days may be the only thing that matters, and as long as the consumer merchant 104 maintains a high level of spend through its payment account for the last 30 days (such that a generally high level of reward points are also maintained in the corresponding reward account for the last 30 days, or not), the consumer merchant 104 will maintain its search benefit (e.g., it will remain at a high level of search hits, etc.). However, if the consumer merchant 106 suddenly spends less during one 30 day period, its rolling total will decrease and its search benefit will decrease or terminate.

Further, it should be appreciated that because the type of search benefits may impact the visibility of the consumer merchant 104 differently, reward amounts associated with the different search benefits may be different, generally, and/or specifically for different merchants, times of year, durations, etc. For example, a certain keyword may cost 10,000 reward points, while a different keyword may cost 20,000 reward points. Similarly, elevating a search hit to the next page in a search result may cost 10,000 reward points, while elevating the search hit to the top 15 hits may cost 30,000 reward points, and elevating the search hit to the first page of the result may cost 40,000 reward points. Further, elevating a search hit above 50 other search hits or above 50% of the search hits, in a search result, may cost 20,000 reward points, while elevating a search hit above 75% of the search hits may cost 40,000 reward points. Often, in various embodiments, the amount of reward points associated with the search benefit relates to the degree of elevation of the consumer merchant 104 (or the expected manipulation), in certain searches, for the consumer merchant 104 relative to like merchants, etc.

Moreover, in numerous embodiments, when a consumer merchant 104 seeks to redeem the reward points, the reward engine 118 presents at least one, but often multiple different search benefits available for purchase. Upon selection of a particular search benefit, by the consumer merchant 104, and its purchase, the selection is included in the consumer merchant's request to the reward engine 118.

Next in the method 300, upon receiving the request at 312, the reward engine 118 determines if reward points are available in the consumer merchant's reward account for the selected search benefit, at 314. Specifically, when the reward account includes insufficient reward points (i.e., the reward total is less than the amount associated with the search benefit, etc.), the reward engine 118 rejects the request to purchase the search benefit. Conversely, when the reward account is sufficient, the reward engine 118 reduces (e.g., modifies, etc.) the reward total, at 316, by the reward amount required for the selected search benefit. Then, at 318, the reward engine 118 transmits an indicator of the purchased search benefit to the search engine 116. In turn, the search engine 116 receives the indicator of the purchased search benefit, at 320. The indicator may include a description of the particular search benefit selected by the consumer merchant 104, or other information indicating the purchased search benefit (e.g., reward values redeemed, etc.).

After receipt of the indicator of the purchased search benefit, the search engine 116 manipulates the search results, at 322, based on the search benefit, for search requests related to the consumer merchant 104. This may be accomplished in a number of manners including, for example, manipulating the ordering of search hits in a search result, after the hits are identified by the search engine 116, or manipulating the methodologies (e.g., algorithms, etc.) used by the search engine 116 to identify the search hits in the search result (e.g., by weighting one or more factors associated with the consumer merchant 104 and utilized in the search engine's searching methodologies, etc.).

In the exemplary method 300, in response to a search request from a user (e.g., the consumer 102, etc.), the search engine 116 performs a search based on, for example, keywords and/or characters entered by the user, one or more search algorithms, and/or one or more databases related to potential search hits, as is known. Then, prior to providing the search result to the user, the search engine 116 organizes the search hits, within the search result, based on the search benefit. Generally, when the consumer merchant 104 is one of the search hits, the search benefit will cause the search engine 116 to elevate the search hit associated with the consumer merchant 104 above at least one of the other search hits. As can be seen, and as described above, and as is apparent form the examples below, the search benefit can affect the organization and/or ordering of the search hits, whereby the consumer merchant 104 is more visible, etc. to the user requesting the search through the search benefit.

With further reference to FIG. 3, after manipulating the organization of the search hits at 322, and the search result, the search engine 116 causes the results to be displayed, at 324, at the computing device 200 associated with the user, etc. This may include, for example, causing the results to display at presentation unit 206 of computing device 200 associated with the consumer 102.

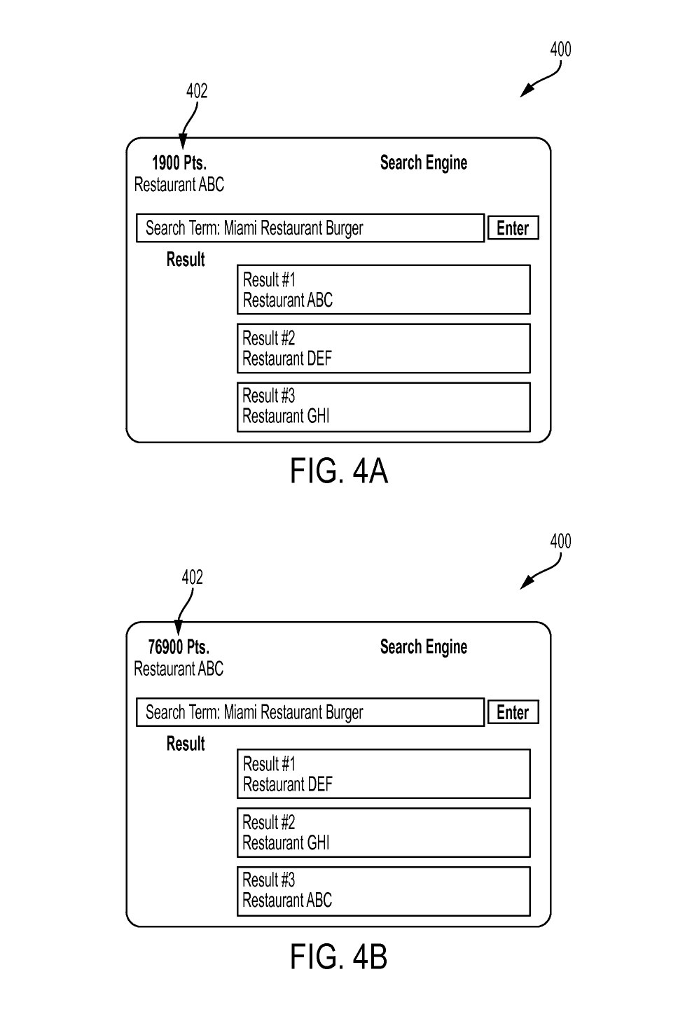

FIG. 4A illustrates an example interface 400, which is caused to be displayed by the search engine 116 in response to a search request by the consumer merchant 104. Here, the user is the consumer merchant 106 and is associated with Restaurant ABC. In addition, the interface 400 also includes a reward total 402 for the consumer merchant 106. Further, in various embodiments notifications and other communications to/from the reward engine 118 (e.g., listings of historical purchases of search benefits, etc.) may be provided through interface 400, or similar interfaces.

More particularly in this example, the interface 400 is displayed in response to a search request, by the consumer merchant 104, for particular keywords. In FIG. 4A, for example, the search terms included: Miami, Restaurant, and Burger. When submitted by the consumer merchant 104, the search engine 118 identified three search hits (in this simplified example): Restaurant ABC (Result #1), Restaurant DEF (Result #2), and Restaurant GHI (Result #3). Also in this example, the consumer merchant 104 purchased a search benefit through the reward engine 118 prior to the search request generating the interface 400. As shown, the search hit corresponding to Restaurant ABC is the top search hit for the search result generated by search engine 116.

In comparison, FIG. 4B illustrates results for the same search request described above and illustrated in FIG. 4A, to the search engine 116, but generated prior to the consumer merchant 104 purchasing the search benefit. As shown in FIG. 4B, the Restaurant ABC search hit is at the bottom of the search result (as defined by the search algorithms, etc. implemented by the search engine 116). In addition, by comparing FIGS. 4A and 4B, it can be seen that the search benefit, which raised Restaurant ABC to the top search hit, cost the consumer merchant 104 a reward point amount of 75,000.

In another example, when a search benefit includes a keyword, the search engine 116 may include the consumer merchant 104 (upon purchasing the keyword) in all search results that relate to the keyword, for a particular interval, regardless of whether or not the consumer merchant 104 is particularly related to the keyword. Here, for example, the keyword may be a popular search term, but may not be particularly related to the consumer merchant 104 (or its business). As an example, the keyword may be “Valentine”. And, the consumer merchant 104 may be a restaurant that does not particularly advertise for Valentine's Day (e.g., the restaurant does not include the word “Valentine” on their site, etc.). By purchasing the keyword “Valentine”, the restaurant can benefit from users searching, through the search engine 116, for Valentine dinner ideas or Valentine date ideas, during the time interval that includes Valentine's Day, as the search engine 116 will identify the restaurant in search results for all searches involving the keyword Valentine (where, without purchasing the keyword, the restaurant would normally not be included in such search results).

The systems and methods herein are described in connection with managing reward points for merchants (e.g., the consumer merchant, etc.), and for facilitating redemption of the reward points through search engines. It should be appreciated, however, that the systems and methods could equally apply to managing reward points for individual consumers, and similarly facilitating redemption of the reward points through search engines, etc.

In addition, it should be appreciated that the reward redemption platform described herein results in little or no costs to the issuer and/or the search engine in connection with the reward redemption (e.g., particularly because no products are required in exchange for redeemed reward points, etc.).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the methods steps herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in altering search results for a consumer merchant, at a search engine that identifies the consumer merchant in connection with one or more searches, the method comprising:
accessing transaction data for a payment account associated with the consumer merchant;
modifying, by at least one server, a reward total associated with the payment account, based on the transaction data to the payment account;
receiving a request, from the consumer merchant, to purchase a search benefit associated with the search engine;
reducing, by the at least one server, the reward total for the consumer merchant by an amount associated with the search benefit; and
transmitting, to the search engine, an indicator of the purchased search benefit to the search engine.

2. The method of claim 1, wherein the search benefit includes association of at least one keyword with the consumer merchant, at the search engine, for a predefined interval, whereby the at least one keyword elevates the consumer merchant in the search results for the consumer merchant by the search engine.

3. The method of claim 1, further comprising transmitting a notification to the consumer merchant when the reward total exceeds or is near at least one threshold;
transmitting, to the search engine, the reward total; and/or
notifying the consumer merchant of the reward total, by the search engine, at an interface associated with the search engine.

4. The method of claim 1, further comprising transmitting a notification to the consumer merchant when the reward total exceeds or is near at least one threshold;
wherein the at least one threshold is said amount associated with the search benefit, or one or more different search benefits.

5. The method of claim 1, wherein the transaction data is associated with multiple transactions to the payment account; and
wherein modifying the reward total includes modifying the reward total based on the multiple transactions to the payment account.

6. The method of claim 1, further comprising:
determining, at the search engine, the search results for the consumer merchant in response to a search request, the search results including a plurality of search hits, the consumer merchant being one of the plurality of search hits; and
organizing the plurality of search hits based at least in part on the search benefit.

7. The method of claim 6, wherein organizing the plurality of search hits includes elevating, by the search engine, the consumer merchant relative to at least one other of said search hits based on the search benefit; and
further comprising causing, by the search engine, the search results to be displayed to a user.

8. The method of claim 1, wherein the request received from the consumer merchant includes a designation of a type of the search benefit.

9. The method of claim 1, further comprising manipulating, by the search engine, the search results based on the search benefit, when the search is associated with the consumer merchant.

10. A system for use in enhancing a result of a search, at a search engine, for a consumer merchant, the system comprising:
a memory including a reward account associated with a payment account, the reward account having a total amount of reward points, and the reward points accumulated in the reward account based on transactions to the payment account; and
at least one processor coupled to the memory, the at least one processor configured to:
receive a request to purchase a search benefit using reward points from the reward account;
reduce the total amount of reward points in the reward account by an amount associated with the search benefit, when the total amount of reward points exceeds said amount; and
transmit the search benefit to the search engine.

11. The system of claim 10, wherein the at least one processor is further configured to receive the request from one of the search engine and an issuer associated with the payment account, based on a selection by the consumer merchant.

12. The system of claim 10, wherein the at least one processor is further configured to modify the total amount of reward points in the reward account based on transaction data for the payment account; and/or
reject the request to purchase the search benefit when the total amount of reward points is less than said amount.

13. The system of claim 10, wherein the at least one processor is further configured to:
retrieve transaction data for the payment account from a payment network, the transaction data associated with multiple transactions to the payment account; and
modify the total amount of reward points accumulated in the reward account based on the multiple transactions.

14. The system of claim 10, further comprising at least one processor associated with the search engine and configured to:
receive the search benefit from said at least one processor;
determine a result in response to a search request associated with the consumer merchant, the result including multiple search hits; and
alter the result of the search request, in response to the received search benefit, when the consumer merchant is one of the search hits.

15. The system of claim 14, wherein the at least one processor associated with the search engine is further configured to cause the search results, including the consumer merchant, to be displayed to a user; and/or
wherein the at least one processor associated with the search engine is further configured to cause the total amount of reward points, at least one reward redemption threshold, and/or search performance metrics, to display at an interface associated with the search engine, to the consumer merchant.

16. The system of claim 10, wherein the at least one processor is further configured to manipulate a result of a search request related to the consumer merchant, based on the search benefit.

17. The system of claim 10, wherein the at least one processor is further configured to manipulate an order associated with search hits in response to a search request, in which the consumer merchant is one of the search hits, based on the search benefit; and
wherein a degree, by which the consumer merchant is elevated in the order, based on the search benefit, at least partially depends on the amount associated with the search benefit.

18. A non-transitory computer readable media including executable instructions which, when executed by at least one processor, cause the at least one processor to:
access transaction data for a payment account associated with a consumer merchant;
modify a reward total associated with the payment account, based on the transaction data to the payment account;
when a request is received from the consumer merchant to redeem reward points for a search benefit at a search engine, reduce the reward total for the consumer merchant by an amount associated with the search benefit; and
transmit an indicator of the purchased search benefit to the search engine.

19. The non-transitory computer readable media of claim 18, wherein the search benefit includes association of at least one keyword with the consumer merchant, at the search engine, for a predefined interval after receipt of the indicator by the search engine, whereby the at least one keyword elevates the consumer merchant in the search results for the consumer merchant by the search engine.

20. The non-transitory computer readable media of claim 19, wherein the executable instructions, when executed by the at least one processor, further cause the at least one processor to transmit a notification to the consumer merchant when the reward total exceeds at least one threshold, wherein the at least one threshold is said amount associated with the search benefit.
